(19) United States
(12) Patent Application Publication
(10) Pub. No.: US 2007/0039004 A1
(43) Pub. Date: Feb. 15, 2007

(54) Decentralized coordination of resource usage in multi-agent systems

(75) Inventors: Valerie Guralnik, Orono, MN (US); Thomas A. Wagner, Minneapolis, MN (US); John A. Phelps, Newport, ME (US)

Correspondence Address: SCHWEGMAN, LUNDBERG, WOESSNER & KLUTH, P.A., P.O. BOX 2938, MINNEAPOLIS, MN, 55402, US

(73) Assignee: Honeywell International Inc.

(21) Appl. No.: 11/204,816

(22) Filed: Aug. 15, 2005

(51) Int. Cl. G06F 9/46

(52) U.S. Cl. 718/104

(57) ABSTRACT

Systems and methods operable on a network to coordinate resource utilization amongst agents in a multi-agent systems in a decentralized manner. In one embodiment, this includes interconnected agents that circulate coordination keys amongst coordination group members. The coordination key includes information defining the coordination group, resources coordinated by group members, and information about scheduled resource utilization. In some embodiments, each agent in a coordination group determines its local schedule of resource utilization based on information in the coordination key to achieve its local goals while coordinating with other agents to achieve coordination group goals.

### GOVERNMENT FUNDING

The invention described herein may have been made with U.S. Government support under Grant Number F30602-03-C0010. The United States Government may have certain rights in the invention.

### TECHNICAL FIELD

The subject matter of this document relates to coordinating resource usage and, more particularly to decentralized coordination of resource usage in multi-agent systems.

### BACKGROUND INFORMATION

The scheduling of agents in a multi-agent system has generally been performed in a centralized manner. Such systems include a global scheduling agent to schedule tasks in an optimal fashion. However, scheduling processes that optimize a schedule can be time consuming as they struggle to find an optimal solution. Further, such global scheduling agents provide a single point of failure.

### BRIEF DESCRIPTION OF THE DRAWINGS

FIG. 1A is a block diagram of agents and a resource according to an embodiment.

FIG. 1B is a block diagram of agents and a resource according to an embodiment.

FIG. 1C is a block diagram of agents and resources according to an embodiment.

FIG. 1D is a block diagram of agents and resources according to an embodiment.

FIG. 2 is a schematic block diagram of agents and resources according to an embodiment.

FIG. 3 is a schematic block diagram of an agent system according to an embodiment.

FIG. 4 is a block diagram of a method according to an embodiment.

### DETAILED DESCRIPTION

In the following detailed description, reference is made to the accompanying drawings that form a part hereof, and in which is shown by way of illustration specific embodiments in which the subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software, or a combination of software and hardware in one embodiment. The software comprises computer executable instructions stored on computer readable media such as memory or other type of storage devices. The term “computer readable media” is also used to represent electromagnetic carrier waves on which the software is transmitted. Further, such functions correspond to modules, which are software, hardware, firmware, or any combination thereof. Multiple functions are performed in one or more modules as desired, and the embodiments described are merely examples. The software is executed on a digital signal processor, an application specific integrated circuit (“ASIC”), a microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an ASIC. Thus, the exemplary process flow is applicable to software, firmware, and hardware implementations.

Agents have objectives. To achieve these objectives, agents perform tasks and consume resources. In some embodiments, agents perform data processing tasks which consume computing resources. In some embodiments, agents are individuals or teams that perform tasks, the performance of which utilizes resources. In yet other embodiments, agents schedule utilization of one or more resources.

The resources agents utilize can include one of a kind resources, multiple resources of the same type, function, or ability, or any combination of these resource types. In some embodiments, these resources are things such as tools, geographic spaces, and processing time on computing resources such as servers. In some embodiments, these resources can also include agents. For example, an agent that is also a resource includes an agent that performs tasks, the results of which are needed by another agent. In multi-agent environments, the agents compete for some of these resources.

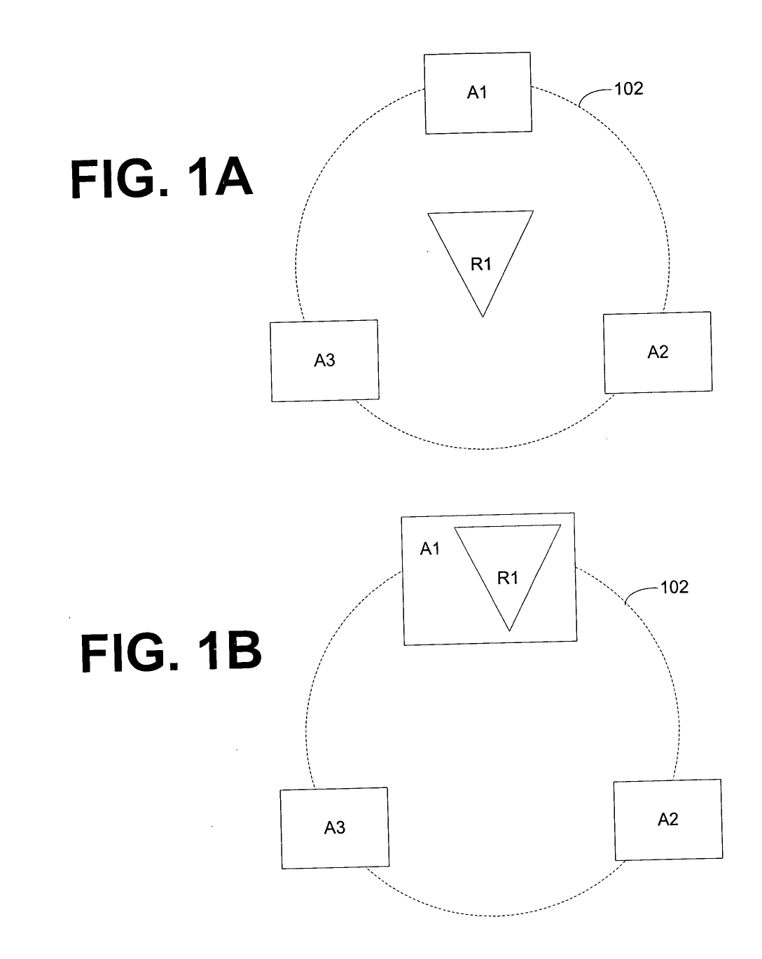

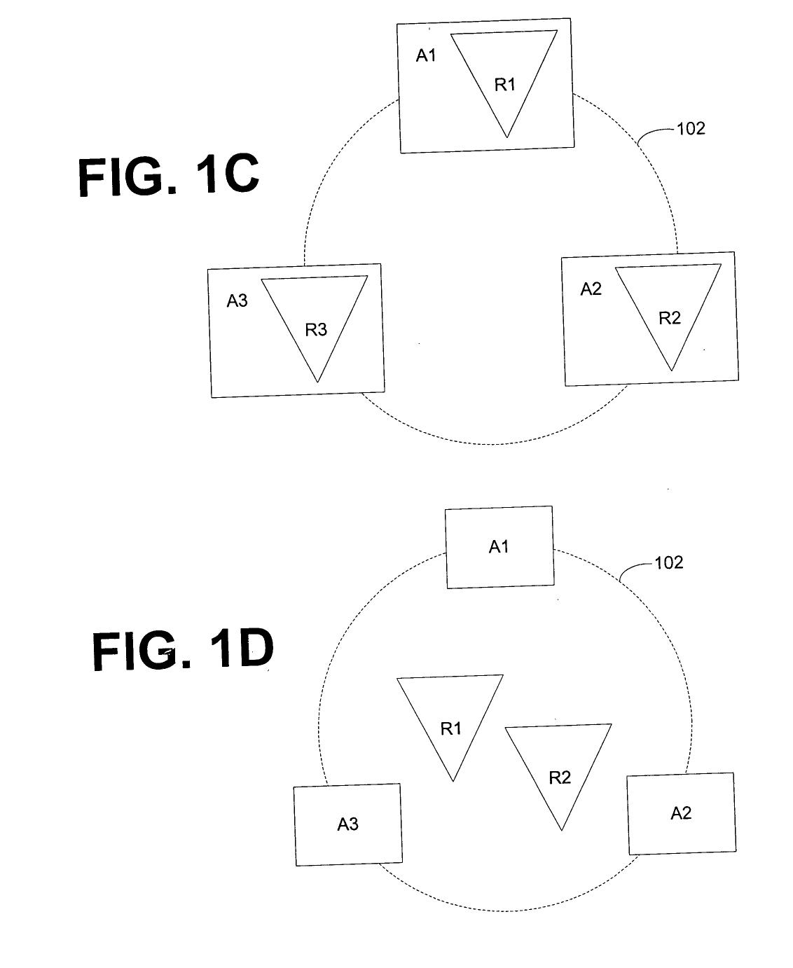

FIG. 1A illustrates an example of agents that compete for a one of a kind resource. Agents A1, A2, and A3 compete for resource R1. Resource R1, can be a geographic space, a tool, a computing resource, or other one of a kind resource. Agents A1, A2, and A3 are any agent that competes to utilize resource R1.

FIG. 1B illustrates another example of agents that compete for a one of a kind resource. However, the example of FIG. 1B includes the resource R1 as part of agent A1. This illustrates, for example, a situation where the resource R1 is a skill of agent A1. The other agents A2 and A3 utilize agent A1 for the skill resource R1. Thus, agents A2 and A3 compete in this example for use of R1. Agent A1 can utilize the resource R1 or share the resource R1 with Agents A2 and A3.

FIG. 1C illustrates an example of agents A1, A2, and A3 each having a respective resource R1, R2, and R3. Resources R1, R2, and R3 are identical or similar resources, such as the skill each agent A1, A2, and A3 possesses that may be useful to other agents. Thus, agents A1, A2, and A3 coordinate with one another to balance utilization of resources R1, R2, and R3 to meet both resource utilization objectives and individual agent objectives.

FIG. 1D illustrates another situation where agents A1, A2, and A3 coordinate utilization of resources R1 and R2 that can be utilized identically or similarly. Resources R1 and R2, in this instance are homogeneous resources.

The examples illustrated in FIG. 1A, FIG. 1B, FIG. 1C, and FIG. 1D each illustrate agents A1, A2, and A3 that coordinate resource utilization via communication over a network 102 that operably interconnects the agents. Coordination of resource utilization allows the agents A1, A2, and A3 to utilize resources in a manner to achieve resource utilization objectives, agent goals, and/or prevent potential problems. Resource utilization objectives can include load balancing across a group of resources, coordinated utilization of a one of a kind resource, schedule optimization, maximum throughput, availability of a resource, or virtually any other goal that can be accomplished via coordinated resource utilization. Agent goals, or objectives, can include performance of a task, meeting a deadline, coordinating utilization of a resource with a competing agent, and coordinating the agents schedule to perform tasks while waiting for a resource to become available that the agent competes for. Some potential problems agents coordinate to prevent include, for example, resource under/over utilization, agent idle time while waiting for a resource to be available, and other problems that can occur when coordinating utilization of resources for which agents compete.

Thus, when coordinating resource utilization in a multi-agent environment, there are several considerations to take into account. These considerations include limited resource availability, potential agent and resource under and/or over utilization, and tasks that cannot be performed in concert due to limited resources or other resource constraints. Other resource constraints can be based on properties of certain resources such as fuel which can not be delivered by an agent while a certain other resource is being utilized, such as a welder. The scheduling of agent tasks and resource usage, in some embodiments, further needs to optimize task performance and resource usage to provide coordinated efficiency. The optimization, in some embodiments, provides problems such as workload balancing between agents and between resources and optimizing agent and resource utilization. The subject matter herein solves these problems, and others, by optimizing schedules in a robust manner by providing resource utilization coordination mechanisms that facilitate agent communication and simplify the coordination process.

The coordination mechanisms include software agents in a networked environment. The software agents can perform one or more functions including the performance of tasks, utilizing one or more resources, and scheduling resource utilization.

Software agents, such as agents A1, A2, and A3 of the embodiments illustrated in FIG. 1A-D, operate by circulating one or more coordination keys amongst one or more coordination groups of software agents, such as in a peer-to-peer fashion on a suitable network, such as network 102. A coordination group is a group of software agents that coordinate resource schedules with one another. The coordination groups are defined in coordination keys and include a representation of each software agent in the coordination group. Examples of a coordination group include agents A1, A2, and A3 of FIG. 1A which coordinate utilization of resource R1. The agents A1, A2, and A3 as individually illustrated in each of FIG. 1B-D are coordination groups as well to coordinate utilization of the resource(s) of the respective illustration.

Software agents coordinate resource utilization using coordination keys when they need a resource that another software agents also needs. Software agents also coordinate when the needed resource includes a one of a kind or other resources of limited quantity or availability.

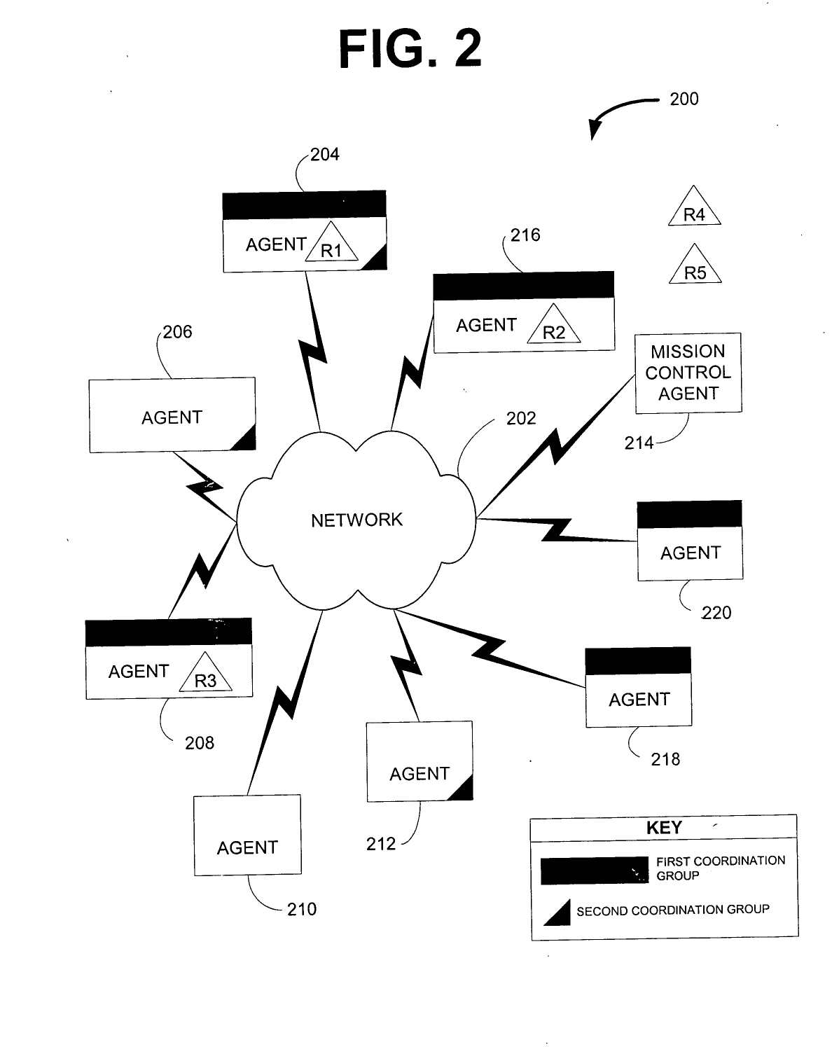

FIG. 2 is a schematic block diagram according to one example embodiment. FIG. 2 illustrates a system 200 including a mission control agent 214 and software agents 204, 206, 208, 210, 212, 216, 218, and 220 operably interconnected via a network 202. The software agents 204, 206, 208, 210, 212, 216, 218, and 220 are organized in coordination groups to coordinate usage of resources R1, R2, R3, R4, and R5. A first coordination group includes software agents 204, 208, 216, 218, and 220 that coordinate utilization of resources R1, R2, and R3. A second coordination group of software agents 204, 206, and 212 coordinate usage of resource R4. Software agent 210, not being a member of a coordination group, utilizes resource R5 without having to coordinate with other the software agents.

The first coordination group includes software agents 204, 208, 216, 218, and 220 which coordinate utilization of resources R1, R2, and R3. (The first coordination group of software agents is identified in FIG. 2 by the black bar at the top of the illustrated agent blocks.) The software agents 204, 208, 216 218, and 220 of the first coordination group coordinate utilization of resources R1, R2, and R3 for various purposes. Some such purposes include load balancing, prevention of resource over/under utilization, efficiency, achievement of software agent goals, and achievement of coordination group goals. The second coordination group includes software agents 204, 206, and 212 which compete within the second coordination group to utilize resource R4. The software agents of the second coordination group coordinate utilization of resource R4 with one another to ensure that all software agents of the second coordination group have an opportunity to utilize resource R4 to achieve individual software agent goals. (The second coordination group of software agents is identified in FIG. 2 by the black triangle in the lower right-hand corner of the illustrated software agent blocks.) Software agent 204, being a member of both the first and second coordination groups, coordinates with both the first and second coordination groups. Software agent 210, not being a member of either the first or second coordination groups, does not coordinate utilization of resource R5 with other software agents.

The mission control agent 214 receives input identifying goals. Some identified goals can include service level objectives for system 200 performance, price cap goals, and productivity goals. Other goals can include the completion of a job by a certain time, such as a data processing job or service to a fleet of vehicles. Each goals is communicated from the mission control agent 214 over the network 202 to at least one software agent in each coordination group or individual agents that are affected by the goal. The agents then coordinate within their coordination groups to achieve the goal, or at least approach accomplishing various parameters of the goal.

In some embodiments, the mission control agent 214 can also receive input regarding specific tasks that are needed and distribute the specific task information to agents as necessary. In other embodiments include the mission control agent function performed by any of the software agents 204, 206, 208, 210, 212, 214, 216 218, and 220 instead of the dedicated mission control agent 214.

After the software agents receive goal information from the mission control agent 214, the software agents coordinate resource utilization and task performance according to the goals. For example, the first and second coordination groups coordinate resource schedules amongst the software agents of their respective coordination groups via a coordination key. A coordination key includes a member representation of member software agents in a group that coordinate resource schedules with one another. For example, the first coordination group coordination key includes a member representation of agents 204, 208, 216 218, and 220. The second coordination group coordination key includes a member representation of software agents 204, 206, and 212. The member representation of a coordination key specifies the other software agents with whom the member software agents coordinate resource commitments. Although FIG. 2 illustrates an embodiment including two coordination groups, other embodiments can include a single coordination group or more than two coordination groups. Further, the content of the member representation varies according to requirements of each embodiment and the environment in which the embodiment is utilized.

A coordination key further includes a representation of resources to coordinate utilization amongst coordination group members specified in the member representation. For example, in a coordination group coordination key, the resource representation provides a representation of one or more resources that either should not, or must not, be concurrently scheduled. A further example, in some embodiments including a coordination group having software agents that compete to utilize a resource, such as software agents 204, 206, 212, the resource representation provides a representation of resource R4 that the software agents 204, 206, and 212 compete for.

The representation of resources within coordination keys can further include additional information about each resource to be coordinated amongst the members of a coordination group specified in the member representation. This information can include a resource cost and a quality value to utilize a resource or to perform a task utilizing the resource. In some embodiments, the information about each resource is assigned to each resource by the mission control agent 214 when the goals are input. In other embodiments, software agents add all or portions of this additional data to the resource representations. However, the content of the resource representation varies according to requirements of each embodiment and the environment in which the embodiment is utilized.

In embodiments including resource quality values, the quality value provides a mechanism by which software agents can determine the importance of a particular software agent utilizing a resource at a certain time. The importance of utilizing the resource, in some embodiments, is related to a deadline by which a goal needs to be achieved or a data process that the resource utilization is a part of must be completed. In some embodiments, each software agent determines when a resource is utilized by an agent to accomplish a goal according to a quality-accumulation-function. This determination is subject to such constraints as when other agents need to use the resource. The quality-accumulation-function takes into account the quality value of resource utilization at a particular time. The resource utilization time period having a higher result from the quality-accumulation-function selected first. An example of a quality-accumulation-function of some embodiments is a sum of all resources utilized and tasks utilizing resources already performed, or scheduled prior to a pending task of a goal, such as having an aircraft or a process operating on a computing device completed by a certain time. This sum increases as the goal approaches an accomplished state. In some other embodiments, the quality-accumulation-function can be static based on resource or based on the task that utilizes the resource. In yet another embodiment, the quality-accumulation-function can be dynamic based on additional considerations such as a deadline of a task needing a resource or relationship between tasks needed to accomplish an overall goal for an agent or a group of agents. The result is coordination of resource utilization and performance of tasks utilizing resources in a fashion to maximize goal accomplishment. In some embodiments, the application of the quality-accumulation-function by software agents is performed on a recurring basis to make coordinated utilization adjustments which allow adjustment for evolving resource requirements, utilization variances, dynamic resource availability, and other variables and intangibles that may be present in a particular dynamic environment.

If individual software agents optimize only individual schedules for local efficiency, the result might be several goals partially accomplished, but no single goal accomplished. The quality value and the quality-accumulation-function are used to allow individual software agents to manipulate resource utilization in a fashion to meet the goals set by the mission control agent 214.

In other embodiments, the quality-accumulation-function includes other information such as a resource cost and a resource utilization duration. The quality-accumulation-function can be manipulated or otherwise altered to modify how software agents respond to goals within the system 200.

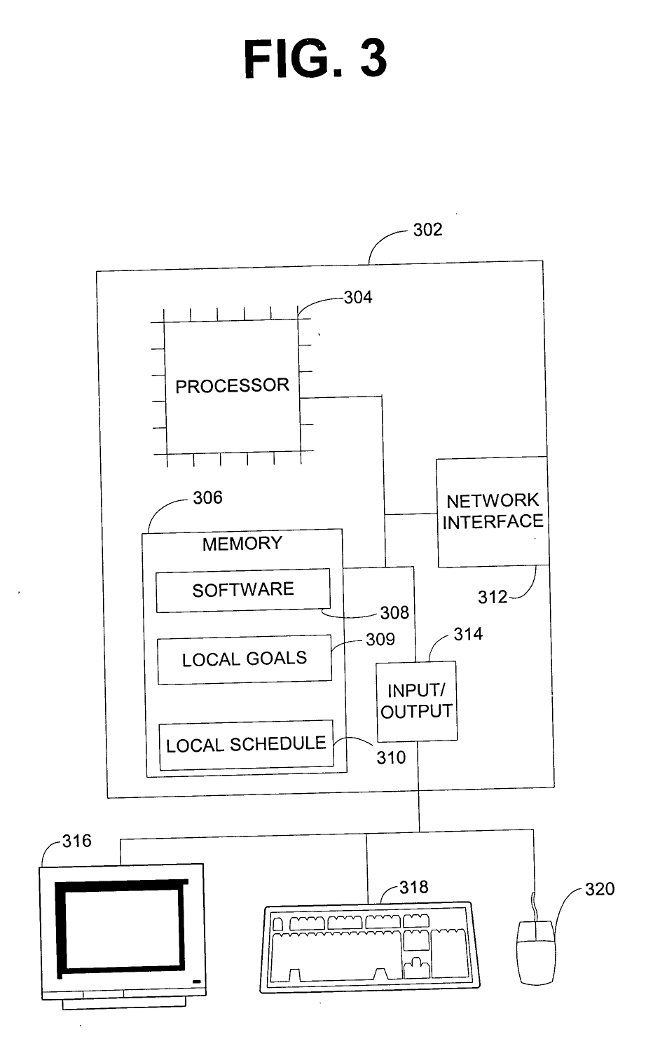

FIG. 3 is a schematic block diagram according to an embodiment. FIG. 3 provides an illustration of a system 302 on which a software agent, such as software agents 204, 206, 208, 210, 212, and 216 of FIG. 2, operates. The software agent of the system 302 performs tasks, represents a resource that is utilized by software agents, or both in a coordinated fashion determined by the software agent and other software agents in a multi-agent system. The system 302 includes a processor 304, a memory 306, a network interface 312, and an input/output interface 314.

The processor 304 of the system 302 represents a digital signal processor or processing unit of any type of architecture, such as an ASIC (Application-Specific Integrated Circuit), a CISC (Complex Instruction Set Computing), RISC (Reduced Instruction Set Computing), VLIW (Very Long Instruction Word), or hybrid architecture, although any appropriate processor may be used. The processor 304 executes instructions, such as instructions included in the software 208 stored in the memory 306. In some embodiments, the processor 304 also includes a control unit that organizes data and program storage in memory 306 and transfers data and other information in and out of the system 302.

The memory 306 represents one or more mechanisms to store data. For example, the memory 306, in various embodiments, includes one or more of a read only memory (ROM), random access memory (RAM), magnetic disk storage media, optical storage media, flash memory devices, and/or other volatile and non-volatile machine-readable media. In other embodiments, any appropriate type of storage device or memory 306 can be used. Although only one memory 306 is shown, multiple memories 306 and multiple types of storage devices can be present.

The network interface 312 represents an interface providing the system 302 with the ability to communicate on a network, such as network 202 illustrated in FIG. 2. In some embodiments, the network interface 312 includes a wired Ethernet network interface card (NIC). In other embodiments, the network interface 312 includes a wireless network interface adapter communicating with a network via a protocol such as the Institute of Electrical and Electronics Engineering (IEEE) standard 802.11(g). Other embodiments include various other types of wired and wireless network interfaces utilizing virtually any protocol allowing the system 302 to communicate on a network. Although only one network interface 312 is shown, multiple network interfaces 312 of various types can be present.

The input/output interface 314 can be operatively coupled to one or more input/output devices. Some such input/output devices include a display 316, a keyboard 318, and a mouse 320. Other input/output devices can include a printer, a plotter, an audio output device such as a sound card and speakers, and virtually any other device capable of receiving stimulation for the system 302 and outputting representations of data or states of the system 302. These input and output devices receive stimulation from a user and provide output to the user. The output can include a visual representation of the local schedule of tasks 310 that a software agent operating on the system is to perform.

The memory 306 includes software 308 to cause the system 302 to operate as a software agent in a multi-agent system. The software 308 is stored in the memory 306 and operable on the processor 304 to receive, manipulate, and send one or more coordination keys. The software 308 is further operable on the processor 304 to store local goals 309 and a local schedule 310 in the memory 306. The local goals 309 are goals can be present and future goals either set locally on the system 302, received from a mission control agent, or determined by the software 308 sensing needs within a multi-agent system. The local schedule 310 is a schedule of tasks or resource utilization that directly affects the actions of the software 308 agent operating on the system 302.

The software 308 that causes the system 302 to operate as a software agent in a multi-agent system provides the software agent several abilities. The software 308 enables the software agent to reason about resource utilization and tasks to perform. The software 308 further enables the software agent to reason about the relative value of when and what resources to utilize and tasks to perform. The software agent reasons as a function of spatial, temporal, and resource constraints, and as a function of interactions between resource utilization and tasks coordinated with other software agents in the multi-agent system. The software 308 further provides software agents the ability to coordinate and adapt planned resource utilization and task performance in dynamic situations while maximizing, for example, production, quality, and timeliness of the software agents. The software 308 also provides for coordinated shared access to resources needed in performing tasks and helps the multi-agent system approach macro-schedule optimization through local mechanisms and peer-to-peer communication. Further, software agents, such as the software 308 agent, in the multi-agent system perform micro-schedule optimization within the constraints of the local goals 309. Additionally, the coordination of resource utilization amongst multiple software 308 agents eliminates the single point of failure of global scheduling systems.

The software 308 agent coordinates its schedule only with other software agents of the multi-agent system that impact the resource utilization and task performance of the software 308 agent. For example, the software 308 agent coordinates within a coordination group of software agents that utilize the same or similar resources, are capable of performing the same or similar tasks, or are capable of performing tasks that cannot, or should not, be performed in parallel. By coordinating only with these other software agents reduces coordination complexity within coordination groups by eliminating calculations associated with other software agents whose resource utilization and task performance does not affect the software 308 agent.

In some embodiments, the software 308 agent schedules resource utilization according to an algorithm applied to one or more coordination keys that are each circulated amongst a coordination group of software agents. The operation of the algorithm allows the software 308 agent, when holding the coordination key for a particular coordination group it is a member of, to declare and commit to its intended course of action, evaluate scheduling proposals and commitments of other software agents, and confirm or negate the proposals and commitments of other software agents. Commitments are made by the software agents in a coordination key to communicate planned and proposed resource utilization to other software agents. In some embodiments, a commitment specifies an agent, a resource, and a time and period of commitment. The operation of the algorithm further allows the software 308 agent to make its own resource utilization commitment proposals and read confirmations and negations of its own resource utilization proposals. Further, in some embodiments, the algorithm senses or receives input about needed resources and tasks and includes that information in the coordination key. Thus, the coordination key provides the mechanism by which software agents coordinate resource utilization.

In operation, the software 308 agent receives a coordination key from another software agent in the multi-agent system. The coordination key in this embodiment includes a primary schedule and a secondary schedule. The primary schedule is the current schedule that is being followed by members of a coordination group. The secondary schedule is a schedule proposed by one or more members of the coordination group, but has not been adopted as the primary schedule. The software 308 agent adds any additional resource utilization needs and tasks to the schedules of the coordination key that it senses, receives as input, or otherwise becomes aware. The software 308 agent can use both the primary and secondary schedules from other agents to extract constraints to be put on the software 308 agent's primary schedule. The software 308 agent then proposes schedule modifications and commitments to the schedules based on constraints in both the primary and secondary schedules and application of a quality-accumulation-function.

In other embodiments, the software 308 agent maintains its own schedule and communicates a smaller set of information in a coordination key with other agents, such as time periods a particular agent is planning to use resources. The content of the coordination key and the amount of resource utilization information communicated between software agents varies by the requirements of the particular embodiment and the environment in which the embodiment operates.

In some embodiments, the software 308 agent evaluates a quality score of the primary schedule in view of a quality score of the secondary schedule. The quality scores are the result of a quality-accumulation-function applied to both schedules as described above. The schedule having the higher resultant quality score is set as the preferred schedule. If the schedule adopted as the preferred schedule is not the original primary schedule, the preferred schedule becomes the primary schedule and peer-to-peer schedule modification messages are sent to other software agents whose schedules are modified. In some embodiments, a further evaluation is made on the preferred schedule to determine goals, such as deadlines, that will not be met by the preferred schedule. In some embodiments, the goals that are to be missed are then communicated directly to interested parties, such as other software agents in the multi-agent system or a particular person or entity wanting updates on actual or predicted agent performance, process status, deadlines, or other status information resulting from actual or predicted missed goals. However, in some other embodiments, the software 308 agent can only modify its own schedule. Thus, in such embodiments, the software 308 agent proposes modifications to the schedule of another software agent in the secondary schedule. Those proposed modification do not cause any changes in the primary schedule until accepted by the other software agent.

The software 308 agent then places a copy of its own schedule in the memory 306 as its local schedule 310 and sends the coordination key to another software agent identified in the coordination key's member representation.

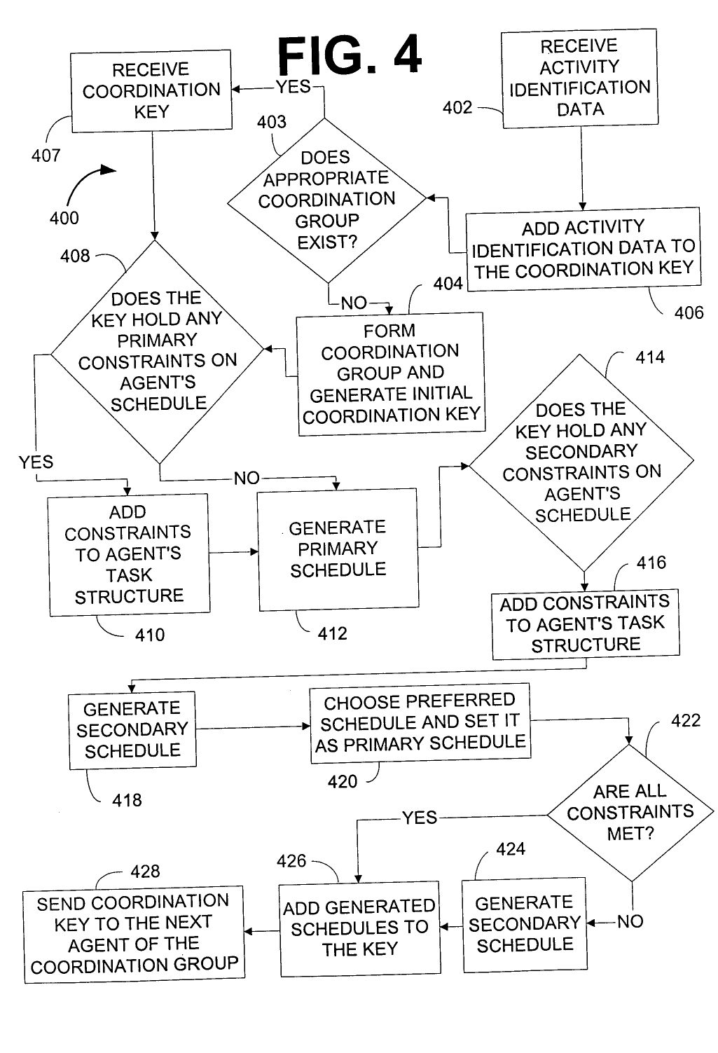

FIG. 4 is a block diagram of a method 400 according to an embodiment. The method 400 is executable on a system to cause the system to operate as a software agent in a multi-agent system. The method 400 includes two points of entry. The first point of entry is receiving activity identification data 402. The second point of entry is receiving a coordination key 412 from another agent.

First pursuing the first point of entry, the method 400 includes receiving activity identification data 402, adding activity identification data to a coordination key 406, and determining if an appropriate coordination group exist 403. For the sake of brevity, the details of a coordination group and a coordination key are described above and not repeated here. If a coordination group does exist, the method 700 determines if the key holds any primary constraints on the agent's schedule 408. If a coordination group does not exist, the method forms a coordination group and generates an initial coordination key 404. Forming a coordination group includes identifying agents that need to coordinate to perform the activity, such as coordination of resources needed for performance of the activity as well as identifying which agents hold the resources, if any. Generating the initial coordination key includes forming the data structure containing the data of the coordination group, such as the member representation and the resource representation as described above. If the appropriate coordination group does exist 403, the method 400 then executes from the second point of entry.

The second point of entry to the method 400 includes receiving a coordination key from another agent 407. The method 400 then determines if the coordination key holds any primary constraints on the agent's schedule 408. A primary constraint on an agent's schedule is a committed constraint and can include agent goals, prior resource commitments, and other scheduling, agent, and resource issues that affect the agent's schedule. An agent can become aware of these primary constraints from the agent's own goals and schedule and also extract the constraints of other agents from their primary and secondary schedules, such as those communicated in a coordination key. If there are constraints, the constraints are added to the agent's local task structure 410.

A primary schedule is then generated 412. A primary schedule is a schedule that agents in the coordination group execute and are committed to. The primary schedule specifies agents to perform certain activities at certain times for certain durations. The method 400 then determines if the coordination key holds any secondary constraints on the agent's schedule 414. A secondary constraint on an agent's schedule is a proposed constraint and can include agent goals, prior resource commitments, and other scheduling, agent, and resource issues that affect the agent's schedule. An agent can become aware of these secondary constraints from the agent's own goals and schedule and also extract the constraints of other agents from their primary and secondary schedules, such as those communicated in a coordination key. If there are constraints, the constraints are added to the agent's local task structure 416. A secondary schedule is then generated 418.

Next, the method 400 chooses a preferred schedule from the primary and secondary schedules and sets the preferred schedule as the primary schedule 420. In some embodiments, the preferred schedule is determined as a function of a quality-accumulation-function. In other embodiments, the selection of the preferred schedule can be manual by a user of a software agent. In yet further embodiments, the preferred schedule is selected based on other criteria such as critical deadlines that must be met, a number of goals met versus number of goals missed, or other criteria as required by the specific embodiment and environment in which the method embodiment is executed.

The method 400 further includes determining if all constraints are met 422. If all of the constraints are not met, a new secondary schedule is generated 424. In some embodiments, this generated secondary schedule 424 is generated to ensure it meets all constraints. The generated schedules are then added to the coordination key 426 and the coordination key is sent to the next agent of the coordination group 428.

After the coordination key is sent to the next software agent 428, the recipient software agent executes the method 400 and eventually forwards the coordination key to another software agent. The coordination key continues to be passed amongst software agents in the coordination group. A schedule resulting from each software agent's execution of the method 400 results in an approximate macro-optimization of the schedule across all software agents in at least one coordination group. The approximate macro-optimization becomes more and more optimal as the coordination key is passed from software agent to software agent. In some embodiments, at the same time the macro-optimization is determined, the local schedule of each software agent executing the method 400 is micro-optimized to the extent possible within the constraints of the macro-optimization.

It is emphasized that the Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this inventive subject matter may be made without departing from the principles and scope of the inventive subject matter as expressed in the subjoined claims.

What is claimed is:

1. A system comprising:
a network;
a first group of agents operative on the network to coordinate resource utilization by multiple agents, wherein the first group of agents coordinate utilization of multiple resources, wherein each resource of the multiple resources can be utilized in a similar manner; and
a second group of agents operative on the network to coordinate resource utilization by multiple agents; wherein the resource is of limited availability.

2. The system of claim 1, wherein the resource of limited availability is a one of a kind resource.

3. The system of claim 1, wherein a resource of the first or second groups belongs to an agent.

4. The system of claim 3, wherein the resource that belongs to an agent is a capability of the agent to perform a task.

5. The system of claim 1, wherein one of the resources is an item utilized in performance of a task.

6. The system of claim 5, wherein the item utilized in performance of a task includes one or more of a tool, a geographic space, a data processing resource, and a skill of an agent.

7. The system of claim 1, wherein the first group of agents and second group of agents each circulate a coordination key for their respective group, each coordination key including:
a member representation including a representation of each member of the respective coordination group;
a resource representation; and
preferred constraints on resource utilization.

8. The system of claim 7, wherein an agent extracts the preferred constraints on resource availability from a primary schedule of resource utilization included in the coordination key.

9. The system of claim 8, wherein each agent, upon receipt of the coordination key, determines if conflicts exist in the schedule and modifies its primary schedule to resolve any conflicts.

10. The system of claim 8, wherein the agent in possession of the coordination key further generates a secondary schedule within the coordination key as a proposal for schedule modifications.

11. The system of claim 10, wherein the secondary schedule is generated as a function of a quality value associated with each resource to be utilized and a quality-accumulation-function.

12. The system of claim 7, wherein the preferred extracted constraints include a deadline constraint by which one or more resource consuming tasks must be completed.

13. The system of claim 7, wherein the primary schedule is modified as a function of a quality value associated with each resource to be utilized.

14. The system of claim 1, wherein at least one of the members of the first group of agents is also a member of another group of agents.

15. The system of claim 1, further comprising:
an agent operative on the network capable of joining existing coordination groups and forming a new coordination group as needed.

16. A system to coordinate resource utilization by an agent in a multi-agent environment, the system comprising:
a network interface;
a memory;
a processor;
software stored in the memory and operable on the processor to cause the system to:
communicate with other agents over the network interface to coordinate resource utilization;
store a local schedule of the agent's scheduled resource utilization in the memory;
receive a coordination key from another agent, wherein the coordination key includes:
a member representation identifying a coordination group of agents that coordinate resource utilization,
a resource representation identifying one or more resources,
a primary schedule of resource utilization, and
a secondary schedule of resource utilization;
resolve conflicts between the local schedule and the primary and the secondary schedules, wherein resolving conflicts includes modifying the local schedule and modifying the primary and the secondary schedules, further wherein conflict resolution decisions are made as a function of a cumulative quality value associated with resources scheduled to be utilized; and
forward the coordination key to another agent identified in the member representation over the network interface.

17. The system of claim 16, wherein the agent extracts primary constraints on resource availability from the primary schedule of the coordination key and extracts secondary constraints on resource availability from the secondary schedule, wherein the agent modifies the primary schedule as a function of the primary constraints and modifies the secondary schedule as a function of the secondary constraints.

18. The system of claim 17, wherein the extracted constraints of the primary and secondary schedules specify a deadline constraint by which one or more resource consuming tasks must be completed, further wherein the cumulative quality value associated with a resource is scaled as a function of the deadline constraint.

19. The system of claim 16, wherein the software is further operable on the system to coordinate resource utilization by the agent with multiple coordination groups, each coordination group defined in a coordination key of each respective coordination group.

20. The system of claim 16, wherein the software is further operable on the system to coordinate the resource utilization by the agent with a coordination group of agents that utilize the same or similar resources and to coordinate the resource utilization by the agent with a second coordination group of agents that utilize a one of a kind resource.

21. A method comprising:
receiving a coordination key from a member agent of a coordination group, wherein the coordination key specifies a period when resources are to be utilized by coordination group members and a deadline by which the coordination group members must release the resources to be utilized by other coordination group members;
scheduling resource utilization and resolving schedule conflicts in a schedule of the coordination key as a function of a quality value associated with each resource; and
forwarding the coordination key to another coordination group member.

22. The method of claim 21, wherein resolving schedule conflicts includes changing the schedule of a coordination group and notifying at least one other coordination group member of the schedule change.

23. The method of claim 21, further comprising:
generating a proposed schedule, wherein resource utilization in the proposed schedule is scheduled to increase the cumulative quality value from resource utilization, wherein the cumulative quality value is calculated as a function of a quality value associated with each respective resource and a deadline by which tasks utilizing resources must be completed.
